(19) United States
(12) Patent Application Publication
(10) Pub. No.: US 2001/0048799 A1
(43) Pub. Date: Dec. 6, 2001

(54) Optical communication system

(76) Inventors: F. David King, Richmond (CA); Yves Tremblay, Nepean (CA)

Correspondence Address: JDS UNIPHASE CORPORATION, INTELLECTUAL PROPERTY DEPARTMENT, 570 WEST HUNT CLUB ROAD, NEPEAN, ONTARIO, K2G 5W8, CA

(21) Appl. No.: 09/826,840

(22) Filed: Apr. 6, 2001

Related U.S. Application Data
(63) Continuation-in-part of application No. 09/082,518, filed on May 21, 1998, now abandoned.

(51) Int. Cl. H04J 14/02

(52) U.S. Cl. 385/125; 359/125

(57) ABSTRACT

A method and system is provided which enables an n channel system to be upgraded into at least an (n−1)+p channel system wherein p>1, and wherein the n−1 channels are substantially wider channels than the p channels. n uncooled inexpensive lasers not requiring optical isolators provide optical signals to the n broad channels, and p temperature compensated cooled lasers having optical isolators provide optical signals to the p channels. Advantageously, the system can be installed at a reasonable cost to the first n users and be upgraded in number of channels and cost as the need for the system to evolve and grow arises. Furthermore, the upgrade accomplished with disruption to only one user whereas the remaining n−1 are not disturbed and can continue to use the system during the upgrade. This obviates the problems associated with justifying the cost of providing p channels for only n subscribers, wherein the p channels require more expensive cooled lasers.

### FIELD OF THE INVENTION

This invention relates to an expandable WDM optical communications system.

### BACKGROUND OF THE INVENTION

Conventional Two-Fiber Transmission

FIG. 1 depicts a conventional two-fiber transmission link where blocks 101 and 102 can represent regeneration or central office sites. Connecting the two sites together is a fiber optic cable. Within the cable there are multiple strands of fiber 103, of which two have been shown. In this type of transmission system, communication from a transmitter (TX) at site A to a receiver (RX) at site B utilizes one signal wavelength (λ1) and one fiber strand of an optical cable. Communication in the opposite direction uses a different strand of the optical cable and the same, or different, wavelength (λ2) to carry the signal.

Referring again to FIG. 1, sites A and B (101 and 102) can represent different site configurations. In one configuration, one terminal site might communicate directly to another terminal site in a complete end-to-end, communication system. Alternatively, FIG. 1 could represent a single link in a longer chain of transmission stations. In other words, sites A and B might be representative of a site C and a site D and a site E and so on, until a final site containing terminating transmission equipment is reached.

Depending upon the wavelength chosen for transmission, the strand of optical fiber 103 used may exhibit different attenuation characteristics which may limit the possible sparing of regenerator sites, e.g., sites A and B. Attenuation in a typical single-mode optical fiber is about 0.35 dB/kilometer at 1310 nanometer (nm) and about 0.25 dB/kilometer at 1550 nm. Thus, for systems operating at data rates of a few gigabits per second, regenerator sites could be spaced anywhere from about 35 to 45 kilometers when operating at 1310 nm and into the 70 to 80 kilometer range when operating at 1510 nm.

Wavelength-Division Multiplexer (WDM) Filters FIG. 2 depict a conventional narrow-band wavelength-division multiplexing communication system. Here, the term “narrow-band” is used to mean that more than one wavelength is utilized within the same transmission “window” of the optical fiber. For example, if the system is operating within a 1550 nm window, two signaling wavelengths of 1533 and 1557 nm might be used. For standard single mode fiber, the two main transmission “windows” of interest are 1310 nm and 1550 nm. Unlike the configuration shown in FIG. 1, communication between site A and site B in FIG. 2 is provided by a single strand of optical fiber 103. Bi-directional transmission is achieved through the utilization of wavelength-division multiplexing (WDM) filters, 201 and 203. (The devices 201 and 203 can be the same or slightly different devices, depending upon the manufacturing technique used to create them.) The purpose of WDM filters is to couple multiple wavelengths into (hereafter referred to as ‘on’) and out of (hereafter referred to as ‘off’) the transmission fiber. In the example shown, WDM filters 201 and 203 couple the two wavelengths 1557 and 1533 nm on and off a single fiber 103 of a fiber optic cable.

WDM Technology

There are several technologies that can be used to construct WDM filters. For example, etalon technology, diffraction grating technology, fused biconic taper technology, and holographic filter technology. One technology that has proven to be widely useful in the telecommunications industry is dichroic filter technology. This technology offers wide channel passbands, flat channel passbands, low insertion loss, moderate isolation, low cost, high reliability and field ruggedness, high thermal stability, and moderate filter roll-off characteristics.

An illustrative example of a conventional three-port dichroic filter 300 is shown in FIG. 3. A dichroic filter is comprised of one or more layers of dielectric material coated onto a, for example, glass substrate 305 with lenses 310 to focus the incoming and outgoing optical signals. The choice of dielectric material, the number of dielectric layers coated onto the substrate, and the spacing of these layers are chosen to provide the appropriate transmissive and reflective properties for a given—target—wavelength. For example, if λ1 is the target wavelength to be transmitted through the filter, the number and spacing of the dielectric layers on the substrate 305 would be chosen to provide (1) a specified passband tolerance around λ1 and (2) the necessary isolation requirements for all other transmitted wavelengths, for example, a wavelength, λ2, transmitted by a second transmitter.

The dichroic, or WDM, filter is constructed by placing self-focusing lenses, such as “SELFOC” lenses 310, on either side of the dielectric substrate 305. “SELFOC” lens 310 focuses incoming light (λ1 and λ2) to a particular location on the dielectric substrate.

Attached to the “SELFOC” lenses through an adhesive bonding process are, typically, single-mode optical fibers. For convenience, the locations at which optical fibers attach to the “SELFOC” lenses 310 are called ports: port 1 320, port 2 325, and port 3 330. Connected to the ports are optical fibers 335, 340, and 345 respectively.

For example, all of the light (comprised of λ1 and λ2) passing through fiber 335 connected to port 1 320 is focused by lens 310 to a single location on the dielectric substrate 305.

Since the substrate is coated to pass wavelengths around λ1, virtually all of the light at λ1 passes through the dielectric substrate 305 and, via the second “SELFOC” lens, is collimated into port 3 330, and passes away from the filter on optical fiber 345. Any other wavelength incident on the filter through port 1 320 (e.g., light of wavelength λ2) is reflected off the multilayer substrate, focused back through the first “SELFOC” lens to port 2 325, and passes away from the filter on optical fiber 340. Likewise, the filter performs the same function for light traveling in the opposite direction. This technology could be used to, for instance, implement WDM filter 201 shown in FIG. 2.

FIG. 4 is a variation of the system shown in FIG. 1, a two-fiber design where one wavelength (λ1) is transmitted on one fiber in one direction, and another (or possibly the same) wavelength (λ2) is transmitted on the other fiber in the opposite direction. Erbium-doped fiber amplifiers (EDFAs) can be deployed along such a link in multiple locations: immediately following the transmitter (TX), making them post-amplifiers; immediately preceding a receiver (RX), making them pre-amplifiers; or between a transmitter and receiver, as shown in FIG. 4, making them line-amplifiers. Commercially available EDFA devices only operate in the 1550 nm window. Typically, in the line-amplifier configuration, regenerator spacing can be almost doubled, from approximately 70 to 80 kilometers to approximately 140 to 160 kilometers. (This analysis assumes typical filter attenuation and that at 80 kilometers the system is attenuation limited and not dispersion limited for distances less than 160 kilometers). Hence, if the cost of two EDFAs is less than the cost of a conventional fiber optics transmission system regenerator, the two EDFAs 401 and 403 can be used to reduce equipment deployment costs when constructing a transmission network such as that shown in FIG. 4.

Illustrative Systems

FIG. 5 depicts one configuration for a dual wavelength, bi-directional narrow-band WDM optical amplifier module, 901. Components used to construct the amplifier module 901 include: two WDMs, 201 and 203 (input and output ports of the amplifier module), and two EDFAs, 903 and 905, which can be either single-pumped or dual-pumped depending upon the communication system's power constraints/requirements. This line-amplifier configuration extends the regenerator spacing while providing bi-directional transmission utilizing a single-fiber strand of the cable facility 103.

It should be noted that the amplifier module 901 can be cascaded to extend even farther the distance between site A and site B. (The number of amplifiers that can be cascaded, between sites A and B, is limited by the dispersion characteristics of the transmission equipment deployed at sites A and B.)

Referring now to prior art FIG. 6, U.S. Pat. No. 5,452,124 describes a bi-directional amplifier module design that can be constructed utilizing a single EDFA. In this configuration, bi-directional transmission over a single optical fiber is achieved using four WDM filters. All signal wavelengths must pass unidirectionally through the EDFA 401 due to the constraint of using optical isolators in the EDFA 401 (refer to FIG. 5). Therefore, the two transmission wavelengths traveling in opposite directions must be broken apart and recombined through WDM filters to pass unidirectionally through the EDFA. Similarly, the two amplified wavelengths must be broken apart and recombined through WDM filters to continue propagating toward their respective receiver sites. WDM filter 203 is constructed to bandpass 1557 nm and WDM filter 201 is constructed to bandpass 1553 nm.

Assuming a typical 1550 nm EDFA operational band, then going through FIG. 6 in a left-to-right direction we see a 1557 nm signal is transmitted from site A 101, through the east WDM filter 203, and onto the fiber cable 103. As the signal enters the amplifier module it is separated by the west WDM filter 201. (Each WDM filter in FIG. 6 has its external connection points labeled either 33 or 57. Connections labeled 33 carry optical signals at the 1533 nm wavelength. Connections labeled 57 carry optical signals at the 1557 nm wavelength.) The signal then travels to the east WDM filter 203 where it is routed into the EDFA amplifier 401. Upon leaving the EDFA, the 1557 nm signal is routed by another west WDM filter 201 to the amplifier module's output east WDM filter 203 where it is placed onto the fiber optic transmission cable 103. Finally, the signal leaves the transmission cable 103, enters the west WDM filter 201 at site B 102, and is routed to that site's receiver equipment. Signals transmitted from site B, at 1533 nm, take a different path through the WDM filters 201 and 203 and EDFA 401 on their way to site A's receiver. An advantage of this prior art embodiment over the configuration described in the earlier prior art of FIG. 5 is that only a single erbium-doped fiber amplifier is required. Because a single amplifier is amplifying multiple wavelengths, it is sometimes preferable that the EDFA 401 in FIG. 6 uses a dual-pumped amplifier rather than a single-pumped amplifier. The additional gain provided by a dual-pumped EDFA could compensate for the signal strength lost by virtue of passing it through a number of additional elements.

For some time now, in North America, dense wavelength division multiplexed (WDM) systems having a plurality of channels transmitted on a single optical fiber have been used primarily in long-haul, backbone, Trans-Canada, Trans-United States systems. For example, between major cities in the United States and between major cities in Canada, there are fiber optic backbone routes several hundred kilometers long, having optical fiber amplifiers disposed periodically along these routes, wherein different channels are transmitted at different wavelengths on a single optical fiber.

In larger cities, for example in Toronto, large central offices exist having fiber optic links therebetween, and in some instances complicated mesh structures of optical fiber links exist between some of these central offices. It is also common for fiber optic cables to be provided from these central offices that offer high bit-rate links routed directly into office buildings via an optical fiber carrying data to and from their local PBX. Hence, fiber optic links exist from central office to central office and from central office trunks to private networks.

Currently, many such local installations do not support multi-wavelength multiplexed signals. These local installations are typically in the form of 1310 nm signals in one direction and 1310 nm signals in the other direction, similar to what is shown in FIG. 1, but wherein both optical fibers transmit and receive the same wavelength.

As of late, there is growing concern relating to utilization of optical fiber cable. The installation of additional optical fiber cables is a costly proposition. For example, on long-haul routes, right of ways must often be established and special trains capable of plowing beside a railway route are often required to add new cable on existing routes. Thus, on long haul routes, between cities, wavelength division multiplexing has become an economically viable alternative.

However, within metropolitan areas, typical central offices may be 20 kilometers apart or less, and regenerators are not required. Adding new cable is a variable cost that depends on length. Consequently, adding a short length has generally been considered more economically viable than adding wavelength division multiplexers and demultiplexers, which are considered to be a fixed cost per channel.

So currently and in the past, it has been less expensive to provide short lengths of cable when required, than to implement a WDM system.

Notwithstanding these factors, there is now some interest in using multichannel technology. For example, when a new customer would like a connection to a central fiber cable, and the number of central fibers is limited, WDM systems are being considered. In this instance where some part of the trunk (central fiber cable) cannot support the branches (the customers) demanding the service, there exists a need for a cost effective WDM system.

An example of one proposed cost effective WDM system is that disclosed by Wagner in U.S. Pat. No. 5,221,983. This WDM system is based on a passive architecture for linking the customers to the central office. The configuration is shown schematically in FIG. 7. Referring to FIG. 7, the central office 500 is linked by a fiber optic cable 501 to a remote node 502. The central office is also linked to backbone optical network and may have links to other remote nodes; these links are not shown in FIG. 7. The remote node 502 is connected to 64 subscribers by means of fiber optic cables. In FIG. 7, only 5 subscribers 504-1, 504-2, 504-3, 504-4, and 504-64 and their respective connections by means of fiber optic cables 503-1, 503-2, 503-4, 503-5, and 503-64 are shown.

The downstream communication between the central office and the subscriber is accomplished using only sixteen different wavelengths in the 1.3 μm band. Because there are 64 subscribers, each wavelength is used by four different subscribers. In order to provide a unique independent downstream channel to each of the 64 subscribers, the system uses a combination of wavelength multiplexing and spatial multiplexing to isolate channels having a common wavelength. The downstream communications is accomplished as follows. In the central office 500, sixteen lasers operating in the 1.3 μm band generate light at sixteen different wavelengths. The light from each of these lasers is split into four and coupled into modulators, which impress the downstream data on the 1.3 μm light that is associated with each subscriber. Thus there are 64 sources of modulated light and each source is assigned to an associated subscriber. The light from the modulators is then arranged into four groups (the spatial multiplexing) with each group containing 16 different wavelengths. A group of sixteen wavelengths is combined together using a 16-channel wavelength multiplexer and sent to the remote node 502 on a single fiber. Since there are four groups, four fibers are required in the fiber cable 501 connecting the central office 500 to the remote node 502 in order to carry the downstream traffic being transmitted to the 64 subscribers. In the remote node, each of four groups of 16 wavelengths is demultiplexed to obtain 64 data channels of 1.3 μm light. The light from a data channel is coupled onto the fiber linking the remote node 502 to its associated subscriber. At each subscriber location (In FIG. 7, 504-1, 504-2, 504-3, 504-4, . . . 504-64), there is a receiver, which detects the 1.3 μm light and recovers the data that was impressed on the light by the modulator in the central office 500.

The up-stream traffic from the subscribers is transmitted to the central office using 16 different wavelength channels in the 1.5 μm band and a combination of spatial and wavelength multiplexing. Wagner (U.S. Pat. No. 5,221,983) discloses two embodiments for generating the light in the 1.5 μm band. In one embodiment, the 16 wavelengths are generated in the central office and multiplexed onto a single fiber, which is connected to the remote node. This light is unmodulated, that is it has a constant power and no data signal is impressed on it. At the remote node, the 16 wavelengths are demultiplexed and the power at each wavelength is split equally into four parts. By this means, 64 sources of light are created in the remote node. The unmodulated light from one of theses sources is sent to a subscriber, by coupling it using a 1.5 μm/1.3 μm band multiplexer onto the same fiber that is carrying the downstream traffic at 1.3 μm to the subscriber. At the subscriber location, 1.5 μm light is separated from the 1.3 μm using a 1.5 μm/1.3 μm band demultiplexer and the unmodulated light is sent to a modulator in order to impress the upstream data traffic on it. The modulated 1.5 μm light is then transmitted back to the remote node by means of a second fiber connection between the remote node and the subscriber. In the remote node, the modulated light signals from the 64 subscribers are arranged into four groups with each group having a set of 16 different wavelengths in the 1.5 μm band. The 16 wavelengths in a group are multiplexed together using a 16-channel multiplexer and output is coupled onto one of the four fibers carrying the 1.3 μm downstream light from the central office to the remote node using a 1.5 μm/1.3 μm band multiplexer. In the central office, the 1.5 μm band light is demultiplexed off the 1.3 μm downstream fibers and passed to 16-channel demultiplexers in order to retrieve the 64 channels of 1.5 μm modulated light from the subscribers. Each modulated light source is sent to the receiver associated with its subscriber in order to detect and recover the upstream data signal.

In the second embodiment of the Wagner U.S. Pat. No. 5,221,983, the upstream light is generated at the subscriber location. Thus there is no requirement for 1.5 μm lasers in the central office and the fiber path to supply unmodulated light from the central office to the subscriber location. In this embodiment, the transmission of the upstream data traffic to the central office is as follows. A transmitter in the subscriber location generates 1.5 μm light carrying the upstream data signal. This light is coupled using a 1.5 μm/1.3 μm band multiplexer, into the fiber connected to the remote node that carries the downstream 1.3 μm data signals, i.e. there is bi-directional transmission of 1.5 μm light upstream and 1.3 μm light downstream in a single fiber between the remote and the subscriber. In the remote node, a 1.5 μm/1.3 μm band demultiplexer extracts the 1.5 μm light from the fiber carrying the bi-directional light signals. From this point on, the path for the 1.5 μm light to the central office is the same as in the first embodiment.

The two embodiments have different requirements in terms of fiber cables linking the central office to the remote node and the remote node to the subscribers. In the first embodiment of Wagner U.S. Pat. No. 5,221,983, the fiber cable 501 connecting the central office to the remote node contains 5 fibers—one fiber operating unidirectional to carry the unmodulated 1.5 μm light downstream, and 4 fibers operating bi-directional to carry 1.5 μm modulated light upstream and 1.3 μm modulated light downstream. The fiber cables (503-1. 503-2. 503-3, 503-4, . . . 503-64) connecting the remote node to a subscriber contains 2 fibers—one fiber operates as a two wavelength WDM link to carry the unmodulated 1.5 μm light and 1.3 μm modulated light downstream to the subscriber and the other fiber to carry modulated 1.5 μm data from the subscriber to the remote node. In the case of the second embodiment, the fiber cable 501 linking the central office 500 and the remote node 502 needs only the 4 fibers operating in the bi-directional mode to carry 1.5 μm modulated light upstream and 1.3 μm modulated light downstream. The fiber cables (503-1. 503-2. 503-3, 503-4, . . . 503-64) contains only a single fiber operating in the bi-directional mode to carry 1.5 μm modulated light upstream and 1.3 μm modulated light downstream.

The WDM system proposed by Wagner in U.S. Pat. No. 5,221,983 is cost-effective because it provides a means for sharing the cost of expensive components (particularly the lasers) among several subscribers. It also has the advantage that the remote node is entirely passive, which means inherently, that the maintenance cost will be low. The disadvantage of the passive network architecture is that it is different from the current network architecture, which uses active nodes. Thus this type of WDM system is suited more to new builds rather than expanding an existing network. Furthermore, the means for expanding the passive architecture system is modular. In the case of the embodiments disclosed by Wagner in U.S. Pat. No. 5,221,983 the module size is 64. Therefore an expansion involving less than 64 subscribers is costly. The module size could be reduced, but then there will also be a corresponding loss in the benefits gained from sharing components.

The factors that contribute to the cost-effectiveness of a system are diverse and complex. As the cost and reliability of active optical components decrease, the advantages of a network having a node containing only passive components over a network using active components in the node becomes less significant. Other factors such as compatibility with existing network architecture, the capability to expand gracefully without disrupting or disturbing the other users of the network become more important.

It is an object of this invention to provide such a system.

It is a further object of this invention to provide an evolvable system which as it evolves becomes gradually more expensive but at the same time is cost effective as the number of subscribers increases beyond some predetermined number.

Hence it is an object of this invention to provide a WDM system that is upgradeable and wherein the implementation cost is in some manner related to the number of users.

### SUMMARY OF THE INVENTION

In accordance with the invention, in a system comprising n channels, wherein each of the n channels has a bandwidth of q nanometers, and n temperature uncooled signal sources, each of the n signal sources for operating within a predetermined channel in a predetermined wavelength band, a method of expanding the n channel system into at least an (n−1)+p channel system is provided, comprising the step of replacing at least one of the n temperature uncooled signal sources with p cooled signal sources for operating within p predetermined channels each having a bandwidth of j nanometers, j being substantially less than q.

In accordance with the invention, a method of expanding an n channel system into at least a (n−1)+p channel system is provided, comprising the steps of:

providing an optical multiplexer for multiplexing p optical signals onto a single waveguide;

replacing one of the n uncooled lasers coupled to an optical waveguide with p stabilized lasers for operating within p predetermined channels each having a bandwidth of j nanometers, j being substantially less than q, while not disturbing the remaining n−1 lasers, and,

optically coupling the p lasers with the multiplexer capable of multiplexing the p channels onto the optical waveguide.

In accordance with the invention, a method of expanding an n channel system wherein each channel is associated with a wavelength and has a bandwidth q and wherein n light sources for generating light at n wavelengths with each of the wavelengths corresponding to one of the n channels and wherein the n light signals are coupled to the inputs of a n:1 multiplexer capable of combining the n light signals into a single light signal on an optical waveguide, and a method of expanding the n channel system into at least a (n−1+p) channels wherein the expansion requires the disruption of only one channel and does not disturb the remaining n−1 channels, and comprising the steps of:

replacing one of the light sources with p light sources for generating light at p wavelengths wherein each wavelength is associated with a new channel, and each wavelength has a bandwidth of j nanometers, j being substantially less than q, and each of the p wavelengths being substantially contained within the bandwidth q of the wavelength channel associated with the laser being replaced, and, providing a p:1 multiplexer, and,

optically coupling the p light sources to the inputs of a p:1 multiplexer for combining the p light signals into a single light signal having p wavelengths, and,

optically coupling the output of the p:1 multiplexer to the input of the n:1 multiplexer where said input is that associated with the laser being replaced and the n:1 multiplexer is for combing the light signal having p wavelengths with the n−1 light signals into a single light signal containing (n−1+p) wavelengths and couples it onto an optical waveguide.

In accordance with the invention, a method of expanding a system comprising n subscribers that communicate to the central office through an active remote node, wherein there are provided n wavelength channels for communications with each wavelength channel being associated with one of the n subscribers and each of the n channels has a bandwidth of q nanometers, and wherein the light in the n wavelength channels are coupled to the n inputs of a n:1 multiplexer for combining n light signals into a single light signal containing all the n wavelengths at the multiplexer output and the single light signal is coupled into an optical waveguide connected to the central office, wherein the single light signal containing the n wavelengths is coupled into the input of a 1:n demultiplexer for separating the single light signal into n light signals with each one having a wavelength associated with one of the n subscribers and wherein the outputs of the 1:n demultiplexer are connected to receivers associated respectively with the n subscribers thereby establishing a n wavelength channels for communication between the n subscribers and the central office and,

a method of expanding the n channel system into at least a (n−1+p) channel system thereby providing upstream communications services to p−1 additional subscribers, comprising the step of;

disrupting the communications of at least one of the subscribers without disturbing the communications of the other subscribers, and,

replacing the wavelength channel associated with said disrupted subscriber with p new wavelength channels where each of the p channels have a bandwidth of j nanometers, j being substantially less than q, and have wavelengths being substantially contained within the bandwidth q of the wavelength channel associated with the disrupted subscriber, and, providing a p:1 multiplexer for combining p light signals with wavelengths corresponding to the p new wavelength channels into a single light signal at the output of p:1 multiplexer, and,

connecting the output of the p:1 multiplexer to the input of the n:1 multiplexer where said input is that associated with the disrupted subscriber and wherein the n:1 multiplexer is for combing the light signals containing the p wavelengths corresponding to the p new wavelength channels with the n−1 light signals with wavelengths associated with the n−1 undisturbed subscribers, and transmitting the light signal containing (n−1+p) wavelengths to the central office, and wherein the light signal containing the (n−1+p) wavelengths is coupled to the input of the 1:n demultiplexer for separating the light into n light signals of which one of the outputs is a light signal containing wavelengths corresponding to the p new wavelength channels, and,

providing a 1:p demultiplexer, and,

coupling the output for the light signal containing p wavelengths from the 1:n demultiplexer to the input of a 1:p demultiplexer for separating the light into p lights signals with wavelengths corresponding to p new wavelength channels, and,

providing p receivers with each receiver associated with one of the p new wavelength channels, and,

coupling the outputs of the 1:p demultiplexer to the respective receiver associated with its wavelength thereby establishing one new wavelength channel for communication between the disrupted subscriber and central office, and p−1 new wavelength channels for communications between the p−1 new subscribers and the central office.

In yet another aspect of the invention, a system is provided, comprising:

p+n contiguous channels, each of the n channels having a bandwidth of q nanometers and each of the p channels having a bandwidth of j nanometers, j being substantially less than q;

n uncooled optical signal sources each optical signal source for transmitting within a predetermined channel of the n channels and having a wavelength corresponding to said predetermined channel; and,

p cooled optical signal sources for operating within the p channels, wherein the p channels are sequential channels, the p channels having a combined operating bandwidth less than or equal to q nanometers.

In accordance with the invention, an optical communication system is provided comprising:

an optical waveguide for transmitting a multiplexed optical signal comprising a plurality of wavelengths corresponding to a plurality of channels;

a plurality of separated multiplexer/demultiplexers optically coupled to different portions of the waveguide for multiplexing and demultiplexing the plurality of wavelengths;

n uncooled lasers for providing n optical signals coupled to at least one of the multiplexer/demultiplexers, each of the lasers corresponding to and operable within a different one of n sequential channels, n being an integer greater than one, each channel having a bandwidth of q nanometers, each laser having a center operating wavelength corresponding to a wavelength within a respective channel;

p lasers having cooling means coupled to at least one of the multiplexer/demultiplexers for providing p optical signals, each of the lasers corresponding to and operable within a different one of p channels, p being an integer greater than one, each channel having a bandwidth of j nanometers, wherein j<q, each laser having a center operating wavelength corresponding to a wavelength at the center of a respective channel; and receiver means for receiving the optical signals.

In accordance with the invention, an optical communication system is provided comprising:

an optical waveguide for transmitting a multiplexed optical signal comprising a plurality of wavelengths corresponding to a plurality of channels;

a plurality of separated multiplexer/demultiplexers optically coupled to different portions of the waveguide for multiplexing and demultiplexing the plurality of wavelengths;

n signal sources for providing n optical signals coupled to at least one of the multiplexer/demultiplexers, each of the lasers corresponding to and operable within a different one of n sequential channels, n being an integer greater than one, each channel having a bandwidth of q nanometers, each laser having a center operating wavelength corresponding to a wavelength within a respective channel;

p lasers having cooling means coupled to at least one of the multiplexer/demultiplexers for providing p optical signals, each of the lasers corresponding to and operable within a different one of p channels, p being an integer greater than one, each channel having a bandwidth of j nanometers, wherein j<q, each laser having a center operating wavelength corresponding to a wavelength at the center of a respective channel;

and receiver means for receiving the optical signals.

Advantageously, an n channel system can be upgraded and expanded by selectively replacing at least one channel having a predetermined bandwidth with a plurality of sub-channels having a narrower bandwidth, thereby providing a hybrid optical system having a plurality of channel types.

### BRIEF DESCRIPTION OF THE DRAWINGS

Exemplary embodiments of the invention will now be described in conjunction with the drawings, in which:

FIGS. 1, 2 and 4 are block-diagram representations of some conventional fiber optic communication systems as discussed in more detail above;

FIG. 3 is a block diagram representation of a conventional three-port wavelength-division multiplexer filter;

FIG. 5 is a block diagram representation of a prior art single-module amplifier for bidirectional transmission employing wavelength-division multiplexing and erbium-doped fiber amplifier technology;

FIG. 6 is a block diagram representation of a prior art bidirectional optical amplifier module comprising a single erbium-doped fiber amplifier and four conventional three-port wavelength-division multiplexers;

FIG. 7 is a diagram depicting a prior art WDM system with a passive node.

FIG. 8 is a diagram depicting a 4 channel optical system having a wavelength range corresponding to an ITU wavelength range for a 100 GHz 40 channel system;

FIG. 9 is a diagram depicting the 4 channel optical system of FIG. 8, wherein one of the channels has been replaced with 10 narrower channels; and,

FIG. 10 is a diagram depicting a 4 channel optical system having a wavelength range corresponding to an ITU wavelength range for a 100 GHz 40 channel system and wherein the laser wavelength at room temperature of each channel is in the lower wavelength range of each channel.

FIG. 11 is a schematic block diagram of an optical system having 4 channels; and,

FIG. 12 is a schematic block diagram of an optical system in accordance with the invention, wherein one of the channels, shown in FIG. 11 has been expanded into 10 narrower channels to service nine additional subscribers.

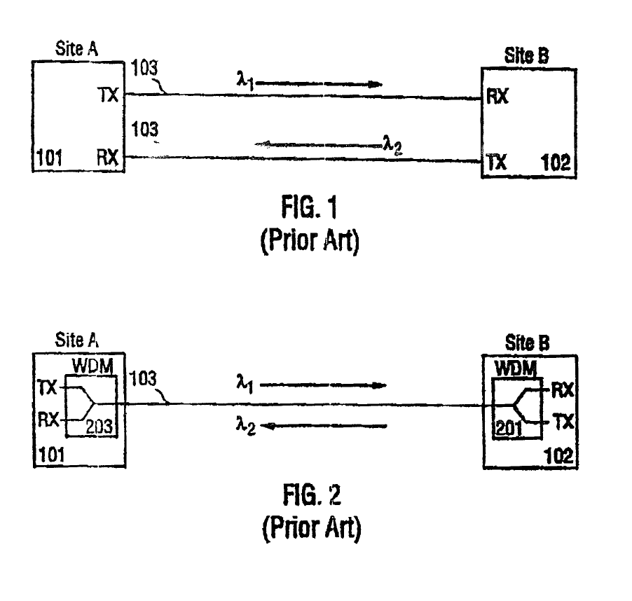

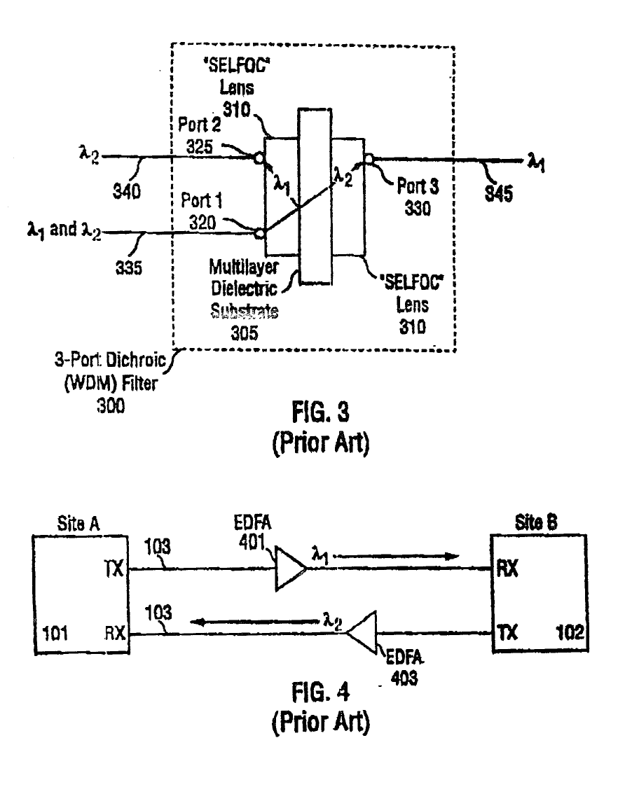

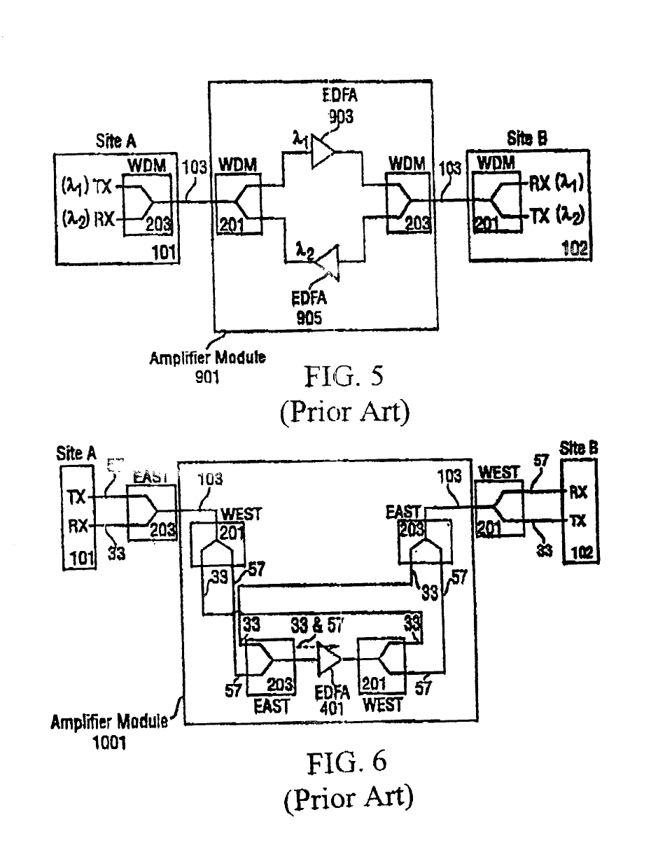

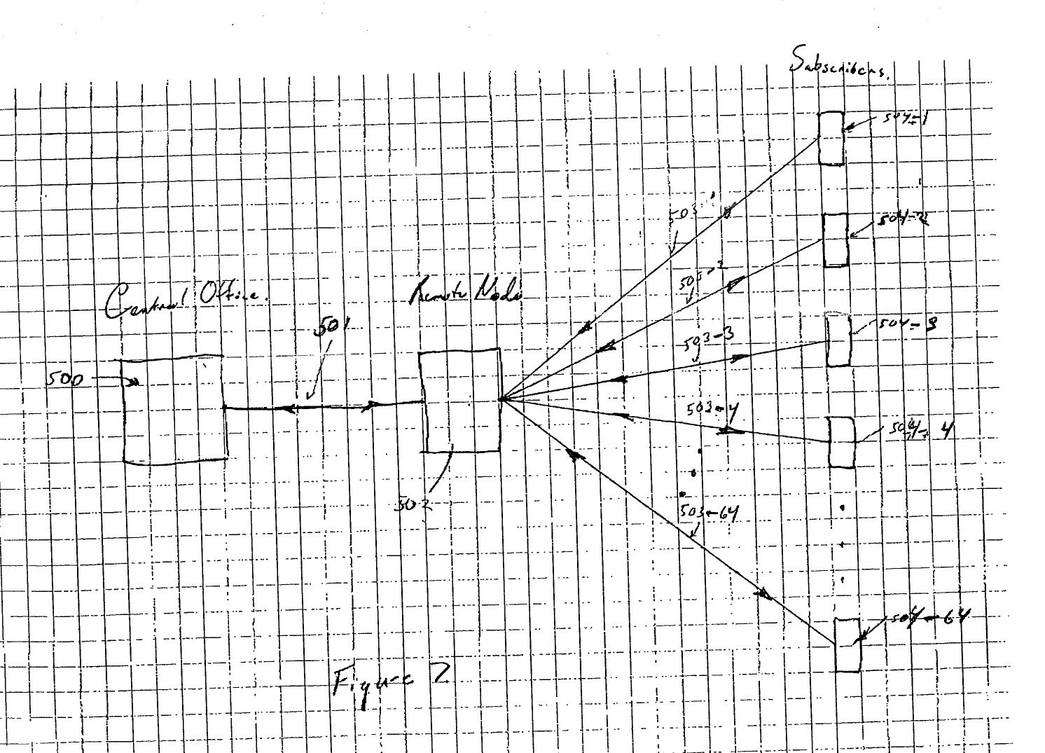

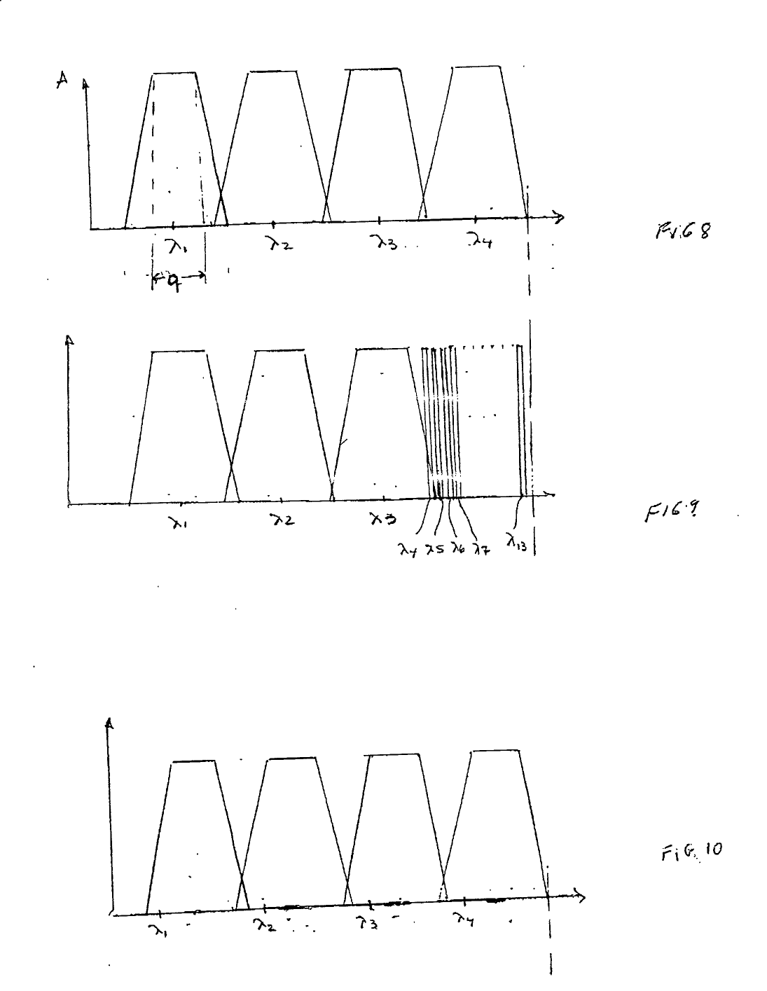

### DETAILED DESCRIPTION

Generally in communications systems, lasers are selected to have a lasing wavelength at ambient conditions that corresponds to a central wavelength of a transmitting channel. The wavelength characteristic of such a system is shown in FIG. 8 wherein a 4-channel system is shown having four center wavelengths λ1, λ2, λ3, and λ4, provided by four optical signal generators, for example lasers, each having a wavelength at ambient temperature that corresponds to a center wavelength of each channel.

Since the channels are n nanometers wide, the system requires lasers that will drift less than n/2 nanometers with changes in operating conditions, for example when operating between 20° C. to 50° C., and/or, in the presence of signal reflections that may be present. Furthermore the system must be tolerant of aging of the lasers. In instances where n is large, and hence, the operating bandwidth of each channel is sufficiently broad, using standard relatively inexpensive lasers may suffice, however temperature compensation in such a system may be required when operating temperatures become excessively high.

Referring now to FIG. 10, a wavelength characteristic for a system in accordance with an aspect of this invention is shown, wherein the wavelengths of the lasers operating at ambient temperature are substantially below the center wavelength of their respective channels. By providing lasers that have a wavelength substantially less than the center wavelength at ambient operating temperature, an increased margin of bandwidth results for allowing the lasers to operate within their allotted band, so as to ensure they remain at a wavelength below their maximum wavelength as the operating temperature increases. This effect provides increased tolerance to drift, since the operating environment in which the lasers must function tends to increase above ambient in a worst case. Temperature control circuitry including an inexpensive heating element is provided (not shown) to ensure temperature of the lasers is at least 20 degrees C. However, by ensuring that the operating wavelength of the laser at room temperature for each channel is in the lower wavelength range of each channel, and that each channel has a broad enough bandwidth to accommodate for the laser drift, expensive stabilized lasers having coolers such as Peltier coolers are not required. Furthermore, these inexpensive lasers do not require built-in isolators in order to avoid back reflections, which are known to cause a broadening of the signal. Since the allowable bandwidth of each channel is relatively broad, slight increase in a particular channel is not deleterious to the system.

Turning now to FIG. 11 a 4 channel optical system in accordance with the invention is shown. The provision of upstream data communications between the subscribers and the Central office is as follows. Data signals originating in transmitters at subscribers' premises 108a to 108d are sent upstream on a 1310 nm light carrier to respective transponders 102a to 102d located in a remote node 150. These 1310 nm optical signals are converted by transceivers 104a to 104d to signals of wavelengths λ1 to λ4 respectively. Thus each of the four subscribers is associated with a unique wavelength of light for transmitting upstream data. Also located in the remote node 150 is a 4:1 multiplexer 100 designed to receive four input light signals in the wavelength band between and including λ1 to λ4. The outputs from the transceivers 104a to 104d are linked by means of fibers 114a to 114d to the four inputs of the 4:1 multiplexer 100. In the 4:1 multiplexer 100, the four signals corresponding to four channels are combined into a single signal on the optical fiber 106 and sent to the Central Office 151. In the Central Office 151, fiber 106 is connected to the input of a 1:4 demultiplexer 120 in which the four wavelengths λ1 to λ4, are separated into 4 light signals with wavelengths λ1 to λ4. Each of these light signals is send by fibers 115a to 115d to the respective receivers 116a to 116d that are associated with the subscribers 108a to 108d.

The provision of downstream signals from the Central Office to the subscriber is as follows. In the Central Office 151 there are transmitters 117a to 117d associated with each subscriber 108a to 108d. The transmitters 117a to 117d generate light at wavelengths λ′1, λ′2, λ′3, and λ′4. It is not necessary that for a particular subscriber, the wavelength used in the upstream transmission of data be the same as that used in the downstream transmission of data. The light signals generated by the transmitters 117a to 117d are sent by respective optical fibers 118a to 118d to the inputs of a 4:1 multiplexer 121 in which the four wavelengths λ′1 to λ′4 are combined and transmitted down a single fiber 119 to the remote node 150. In the remote node, the fiber 119 is connected to the input of a 1:4 demultiplexer 122 in which the light is separated into 4 signals having wavelength λ′1 to λ′4 respectively at the output of the demultiplexer. Each of the 4 light signals is transmitted by respective fibers 123a to 123d to its associated transceiver 124a to 124d in transponders 102a to 102d. The transceivers in the transponder convert the signals at wavelengths λ′1 to λ′4 to 1310 nm light signals which are then transmitted downstream to the their respective subscribers 108a to 108d.

This optical system depicted in FIG. 11 provides a required functionality at a relatively low cost to subscribers. For example, the transponders 102a to 102d are relatively inexpensive devices and do not require expensive coolers. This is due to the fact that a wide spectral window is provided within which they must operate, allowing suitable tolerance to variation in the laser's wavelength. Depending upon the requirements, the wavelength characteristic of the upstream portion of the system in FIG. 11 is exemplified by the characteristics shown in FIG. 8 or FIG. 10, the latter being the preferred embodiment providing increased tolerance to laser drift as a result of a temperature increase. The downstream portion of the system would have a similar wavelength characteristic.

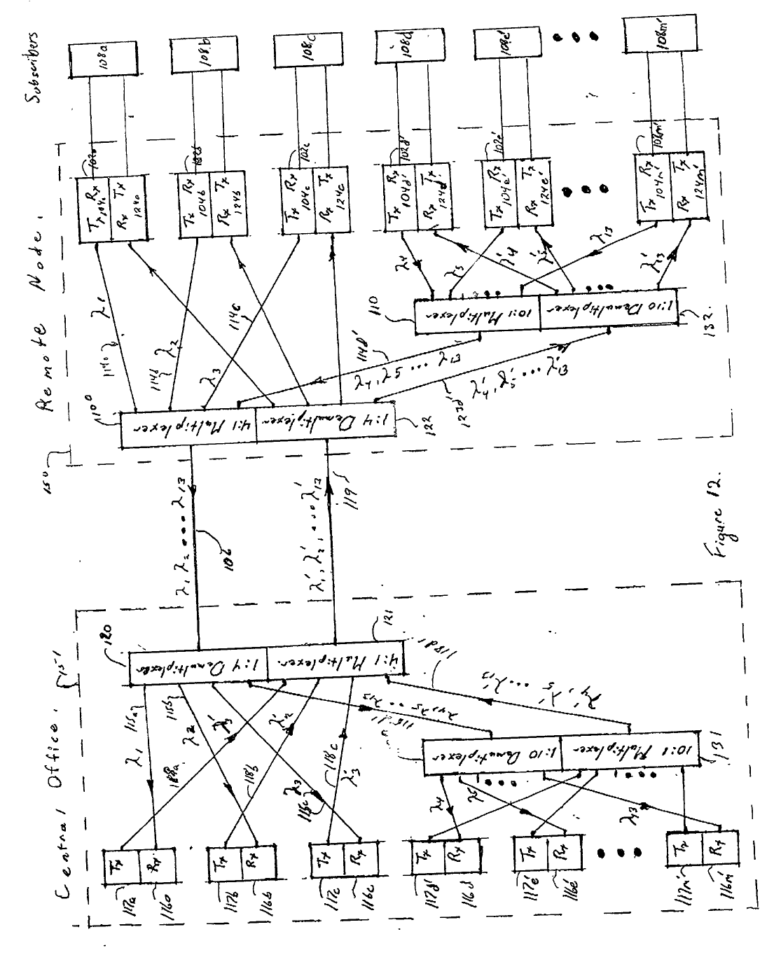

Referring now to FIG. 12, a modified WDM system, similar to the WDM system of FIG. 11 in many respects, is shown. The modified WDM system of FIG. 12 has been expanded to provide communications services to 13 subscribers, which is 9 more than the WDM system shown in FIG. 11. Furthermore, the expansion has been achieved by disrupting the access to communications of only one subscriber. It is also achieved with out disturbing the other subscribers, i.e they can continue to use the system while the modifications are being made. Finally, there is no requirement to install additional optical fiber between the Central Office and the remote node.

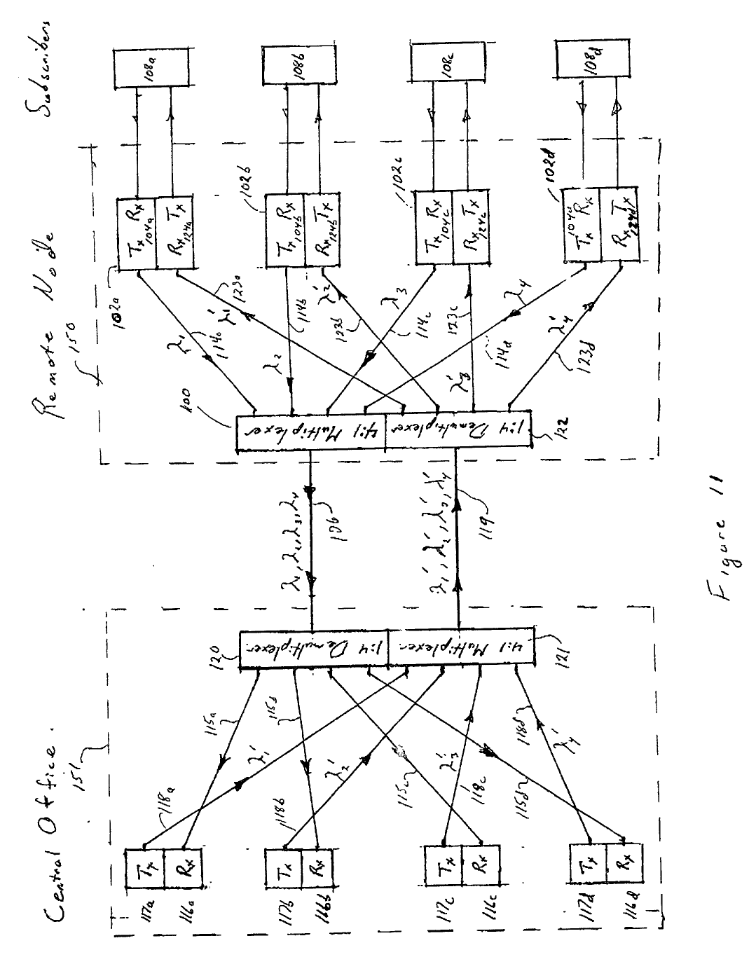

The expansion is implemented as follows. For the purpose of illustration, it is assumed that the communications for subscriber 108d in FIG. 11 is disrupted and nine new subscribers 108e′ to 108m′are added. Consider first the provision of upstream data communications for the ten subscribers 108d, 108e′ to 108m′ to the Central Office. In FIG. 12 the transponder 102d in the remote node of FIG. 11 is replaced with a 10:1 multiplexer 110 capable of multiplexing ten wavelengths λ4 to λ13 onto a single fiber 114d, and ten transponders 102d′ to 102m′ dedicated to subscribers 108d, 108e′ to 108m′. The transponders contain transceivers 104d′ to 104m′ that use a Peltier cooled lasers within the transmitter Tx. These stabilized lasers are considerably more costly than the uncooled lasers used in the system of FIG. 11 and are capable of operating within a very narrow bandwidth. The output from the 10:1 multiplexer 110 is connected by a fiber 114d′ to the input of the 4:1 multiplexer 100 in order to combine the wavelengths λ4 to λ13 with the wavelengths λ1 to λ3. The wavelength characteristic for the combined wavelengths is shown in FIG. 9. It is evident that the width of the channels corresponding to wavelengths λ4 to λ13 is considerably less than the width of the channels corresponding to wavelengths λ1 to λ3. The light signal containing the wavelengths λ1 to λ13, is sent through fiber 106 to the Central Office where it is connected to the input of the 4:1 demultiplexer 120. In the demultiplexer 120, the light is separated into four light signals in which three light signals have unique wavelengths λ1 to λ3 respectively and the fourth light signal contains the wavelengths λ4 to λ13. This fourth light signal is sent through a fiber 115d′ to the input of a 1:10 demultiplexer 130, which separates the light into 10 light signals having respective wavelengths λ4 to λ13. The ten light signals outputs from the demultiplexer 130 with respective wavelengths λ4 to λ13 are transmitted through fibers to respective receivers 116d, 116e′ to 116m′ that are associated with subscribers 108d, 108e′ to 108m′. Thus the upstream communications from the subscribers to the Central Office is expanded to accommodate nine additional subscribers. This expansion in upstream data communications required the addition a 1:10 demultiplexer 130 and nine receivers 116e′ to 116m′ to the in the Central Office and the addition of a 10:1 multiplexer 110 and 10 transceivers 104d′ to 104m′ in the transponders 102d′ to 102m′ in the remote node.

In order to provide downstream communications to the subscribers, the following modifications are necessary. In FIG. 12, ten transmitters 117d′, to 117m′ with narrow band wavelength controlled lasers similar to the type that were used in the remote node for the upstream data transmission, replace the transmitter 117d in FIG. 10. These transmitters generate modulated light signals at wavelengths λ′4 to λ′13 that are associated respectively with subscribers 108d, 108e′ to 108m′. The light from the 10 transmitters is sent to the 10 inputs of a 10:1 multiplexer 131, which combines the ten wavelengths λ′4 to λ′13 into a single light signal. The output from the 10:1 multiplexer 131 is then transmitted through a fiber 118d′ to the input of the 4:1 multiplexer 121 which combines the wavelengths λ4 to λ13 with the wavelengths λ′1 to λ′3. The output from the 4:1 multiplexer 121 is then transmitted down fiber 119 to the remote node and into the 1:4 demultiplexer 122, which separates the light into four signals, three of which have a single wavelength λ′1 to λ′3 and the fourth comprises the ten wavelengths λ′4 to λ′13. This latter light signal is transmitted through a fiber 123d′ to the input of the 1:10 demultiplexer 132 where it is separated into 10 light signals having wavelengths λ′4 to λ′13. The ten outputs from the 1:10 demultiplexer 132 are then connected respectively to their associated transceivers 124d, 124e′ to 124m′. In the transceivers 102d′ to 102m′, the downstream data is converted into 1310 nm light signals which is sent to the respective subscribers 108d, 108e′ to 108m′ thereby completely the downstream communications link from the Central Office to the subscriber. This expansion in downstream data communications required the addition a 10:1 multiplexer 131 and ten transmitters 117d′ to 117m′ in the Central Office and the addition of a 1:10 demultiplexer 132 and 9 receivers 124e′ to 104m′ in the transponders 102e′ to 102m′ in the remote node

In the WDM system of FIG. 12, all subscribers share some common components such as the 4:1 multiplexers and 1:4 demultiplexers in the Central Office and the remote node and the fibers linking the remote node to the Central Office. In order to expand the 4-channel system shown in FIG. 11 to the 13-channel system shown in FIG. 12, only one subscriber 108d needs to be temporarily disturbed. The other three subscribers can continue to use the WDM system without any disruption or disturbance.

In some cases, it may be advantageous to disrupt more than one subscriber in order to expand the system. It is readily recognized by one skilled in the art that the method disclosed here for expanding a WDM system serving n subscribers and only disrupting one subscriber could be extended to the case when more than one subscriber is disrupted.

What is claimed is:

1. A method of expanding an n channel system having n uncooled lasers into at least a (n−1)+p channel system, comprising the steps of:
providing an optical multiplexer for multiplexing p optical signals onto a single waveguide;
replacing one of the n uncooled lasers coupled to an optical waveguide with p stabilized lasers for operating within p predetermined channels each having a bandwidth of j nanometers, j being substantially less than q, while not disturbing the remaining n−1 lasers, and,
optically coupling the p lasers with the optical multiplexer capable of multiplexing the p channels onto the optical waveguide.

2. A method of expanding an n channel system wherein each channel is associated with a wavelength and has a bandwidth q and wherein n light sources for generating light at n wavelengths with each of the wavelengths corresponding to one of the n channels and wherein the n light signals are coupled to the inputs of a n:1 multiplexer for combining the n light signals into a single light signal on an optical waveguide, and a method of expanding the n channel system into at least a (n−1+p) channels wherein the expansion requires the disruption of only one channel and does not disturb the remaining n−1 channels, and comprising the steps of:
replacing one of the light sources with p light sources for generating light at p wavelengths wherein each wavelength is associated with a new channel, and each wavelength has a bandwidth of j nanometers, j being substantially less than q, and each of the p wavelengths being substantially contained within the bandwidth q of the wavelength channel associated with the laser being replaced, and,
providing a p:1 multiplexer, and,
optically coupling the p light sources to the inputs of a p:1 multiplexer for combining the p light signals into a single light signal having p wavelengths, and,
optically coupling the output of the p:1 multiplexer to the input of the n:1 multiplexer where said input is that associated with the laser being replaced and the n:1 multiplexer is for combining the light signal having p wavelengths with the n−1 light signals into a single light signal containing (n−1+p) wavelengths and couples it onto an optical waveguide.

3. A method as defined in claim 2, wherein the n light sources are n uncooled lasers sources.

4. A method as defined in claim 3, wherein at room temperature, the operating wavelength of each of the n uncooled signal sources is substantially near a wavelength corresponding to the mid-point of its associated wavelength channel.

5. A method as defined in claim 3, wherein at room temperature, the operating wavelength of each of the n uncooled signal sources is within the channel bandwidth q but shorter than the wavelength corresponding to the mid-point of its associated wavelength channel.

6. A method as defined in claim 2, wherein the light for the p wavelength channels is provided by p stabilized signal sources being temperature controlled.

7. A method as defined in claim 2, wherein the n channels have wavelengths corresponding substantially to the International Telecommunications Union recommended wavelengths for systems operating at multiwavelengths.

8. A method of expanding a system comprising n subscribers that communicate to the central office through an active remote node, wherein there are provided n wavelength channels for communications with each wavelength channel being associated with one of the n subscribers and each of the n channels has a bandwidth of q nanometers, and wherein the light in the n wavelength channels are coupled to the n inputs of a n:1 multiplexer that combines n light signals into a single light signal containing all the n wavelengths at the multiplexer output and the single light signal is coupled into an optical waveguide connected to the central office, wherein the single light signal containing the n wavelengths is coupled into the input of a 1:n demultiplexer for separating the single light signal into n light signals with each one having a wavelength associated with one of the n subscribers and wherein the outputs of the 1:n demultiplexer are connected to receivers associated respectively with the n subscribers thereby establishing a n wavelength channels for communication between the n subscribers and the central office and,
a method of expanding the n channel system into at least a (n−1+p) channel system thereby providing upstream communications services to p−1 additional subscribers, comprising the step of;
disrupting the communications of at least one of the subscribers without disturbing the communications of the other subscribers, and,
replacing the wavelength channel associated with said disrupted subscriber with p new wavelength channels where each of the p channels have a bandwidth of j nanometers, j being substantially less than q, and have wavelengths being substantially contained within the bandwidth q of the wavelength channel associated with the disrupted subscriber, and,
providing a p:1 multiplexer for combining p light signals with wavelengths corresponding to the p new wavelength channels into a single light signal at the output of p:1 multiplexer, and,
connecting the output of the p:1 multiplexer to the input of the n:1 multiplexer where said input is that associated with the disrupted subscriber and wherein the n:1 multiplexer is for combing the light signals containing the p wavelengths corresponding to the p new wavelength channels with the n−1 light signals with wavelengths associated with the n−1 undisturbed subscribers, and transmitting the light signal containing (n−1 +p) wavelengths to the central office, and wherein the light signal containing the (n−1+p) wavelengths is coupled to the input of the 1:n demultiplexer for separating the light into n light signals of which one of the outputs is a light signal containing wavelengths corresponding to the p new wavelength channels, and,
providing a 1:p demultiplexer, and,
coupling the output for the light signal containing p wavelengths from the 1:n demultiplexer to the input of a 1:p demultiplexer for separating the light into p lights signals with wavelengths corresponding to p new wavelength channels, and, providing p receivers with each receiver associated with one of the p new wavelength channels, and,
coupling the outputs of the 1:p demultiplexer to the respective receiver associated with its wavelength thereby establishing one new wavelength channel for communication between the disrupted subscriber and central office, and p−1 new wavelength channels for communications between the p−1 new subscribers and the central office.

9. A method as defined in claim 8 wherein two or more subscribers are disrupted.
